(19) United States
(12) Patent Application Publication
(10) Pub. No.: US 2011/0234015 A1
(43) Pub. Date: Sep. 29, 2011

(54) COOLING SYSTEM AND SEVER USING SAME

(75) Inventor: TE-MING CHANG, Tu-Cheng (TW)

(73) Assignee: HON HAI PRECISION INDUSTRY CO., LTD., Tu-Cheng (TW)

(21) Appl. No.: 12/842,011

(22) Filed: Jul. 22, 2010

(30) Foreign Application Priority Data
Mar. 29, 2010 (TW) 99109455

(51) Int. Cl. H02J 3/01

(52) U.S. Cl. 307/105

(57) ABSTRACT

A cooling system is used in a server. The server includes an uninterruptible power supply. The cooling system includes a protecting unit, a transformer unit and a alternating current powered fan. The protecting unit is electrically connected to the uninterruptible power supply for suppressing harmful factors in the power provided by the uninterruptible power supply. The transformer unit is electrically connected to the protecting unit for transforming the power outputted from the protecting unit. The alternating current powered fan is connected to the transformer unit for getting power from the transformer unit.

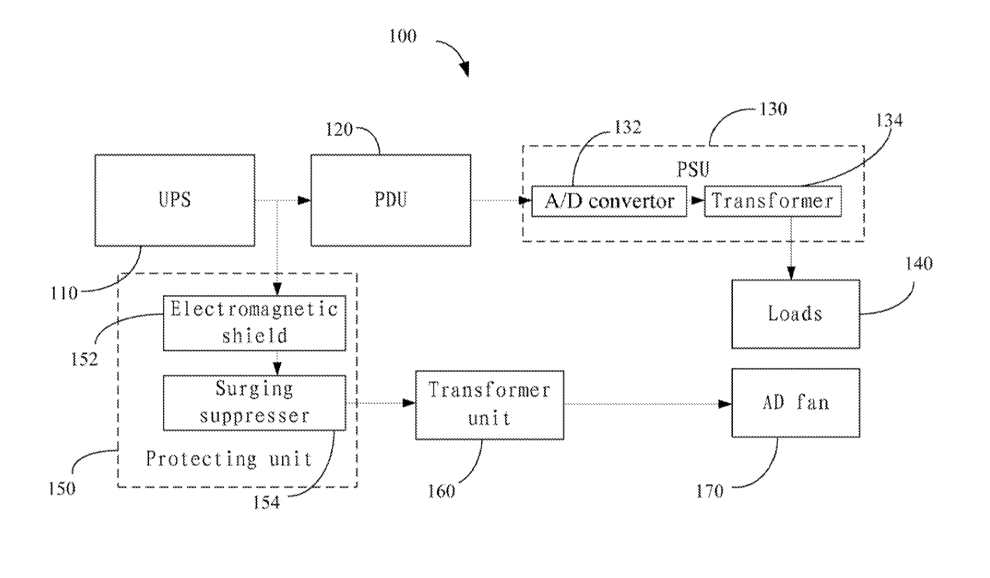

### BACKGROUND

1. Technical Field

The disclosure relates to cooling systems for servers and, particularly, to a cooling system used in a server with lower energy consumption.

2. Description of Related Art

A server is a powerful platform for providing clients with access to files and printers as shared resources to a computer network. In operation, the server generates remarkable heat that raises the temperature in the server which may affect the performance of the server. Therefore, a cooling system such as a fan is employed into the server for cooling. In general, the cooling system is powered by current supplied by a Power Distribution Unit (PDU) after A/C is transformed and modulated. However, the current from the (PDU) is consumed considerably before it reaches the cooling system because the components connected between the PDU and the cooling system may consume more energy than the cooling system.

Therefore it is desirable to provide a cooling system and a server using a cooling system which can overcome the above-mentioned shortcomings.

### BRIEF DESCRIPTION OF THE DRAWINGS

The drawing shows a block diagram of a cooling system for a server in accordance with an exemplary embodiment.

### DETAILED DESCRIPTION

Referring to the drawing, a cooling system 100 in accordance with an embodiment is used in a server, which includes an uninterruptible power supply (UPS) 110, a power distribution unit (PDU) 120, a power supply unit (PSU) 130, and a number of loads 140.

The UPS 110 is configured for supplying reliable power for the server, for protection from an unexpected power disruption, which could cause serious business disruption and/or data loss. In addition, the UPS 110 can also suppress the surging, instantaneous overvoltage/low-voltage, frequency deviation, circuit noise in the power source, thereby stabilizing and upgrading the power quality.

The PDU 120 is electrically connected to the UPS 110 for distributing the power of the UPS 110 to the loads 140, the loads 140 are terminal data processers or accessing components including various systems, units or components, such as the CPU, hard driving disk, memory, or buffers, in the server.

The PSU 130 is electrically connected to the PDU 120 and includes an A/C convertor 132 electrically connected to the PDU 120 and a transformer 134 electrically connected to the A/C convertor 132. The A/C convertor 132 is electrically connected to the loads 140.

The cooling system 100 gets power from the UPS 110, and includes a protecting unit 150, a transformer unit 160, and an alternating current powered fan 170 (“A/C fan 170”). The protecting unit 150 is directly connected to the UPS 110 without the PDU 120 and the PSU 130 electrically connected therebetween. The transformer unit 160 is connected to the protecting unit 150. The A/C fan 170 is connected to the transformer unit 160.

The protecting unit 150 includes an electromagnetic shield 152, and a surging suppresser 154. The electromagnetic shield 152 is electrically connected to the UPS 110 for shielding the electromagnetic radiation that is generated from the UPS 110 and may affect the operation of the server. The surging suppresser 154 is electrically connected to the electromagnetic shield 152 for suppressing the instantaneous overvoltage/low-voltage, which may damage the fan 170.

The transformer unit 160 is electrically connected between the surging suppresser 154 and the fan 170. The transformer unit 160 is configured for modulating and transforming the current output from the protecting unit 150 to the rating current of the fan 170.

In use, the fan 170 gets power from the UPS 110 through the protecting unit 150 and the transformer unit 160 to cool the server. Because the UPS 110 directly powers the fan 170 and the PDU 120 and PSU 130 are removed from the current supplying path of the fan 170, therefore, the energy loss in the PDU 120 and PSU 130 can be eliminated and the energy consumption can be reduced.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A cooling system for a server having an uninterruptible power supply, comprising:
a protecting unit electrically connected to the uninterruptible power supply for suppressing harmful factors in the power provided by the uninterruptible power supply;
a transformer unit electrically connected to the protecting unit for transforming the power outputted from the protecting unit; and
an alternating current powered fan connected to the transformer unit for getting power from the transformer unit.

2. The cooling system of claim 1, wherein the protecting unit comprises an electromagnetic shield, and surging suppresser; the electromagnetic shield is electrically connected to the UPS for shielding the electromagnetic radiation generated from the UPS; the surging suppresser is electronically connected to the electromagnetic shield for suppressing the instantaneous overvoltage and low-voltage; the transformer is electrically connected to the surging suppresser.

3. A server comprising:
an uninterruptible power supply configured for supplying reliable power for the sever;
a power distribution unit electrically connected to the uninterruptible power supply for distributing the power of the uninterruptible power;
a power supply unit connected to the power distribution unit for modulating the current outputted from the power distribution unit;
a plurality of loads electrically connected to the power supply unit for acquiring power fro the power supply unit; and
a cooling system for a server having an uninterruptible power supply, comprising:
a protecting unit electrically connected to the uninterruptible power supply for suppressing harmful factors in the power provided by the uninterruptible power supply;
a transformer unit electrically connected to the protecting unit for transforming the power outputted from the protecting unit; and
an alternating current powered fan connected to the transformer unit for getting power from the transformer unit.

4. The server of claim 3, wherein the protecting unit comprises an electromagnetic shield, and surging suppresser; the electromagnetic shield is electrically connected to the UPS for shielding the electromagnetic radiation generated from the UPS; the surging suppresser is electronically connected to the electromagnetic shield for suppressing the instantaneous overvoltage and low-voltage; the transformer is electrically connected to the surging suppresser.
